(19) United States
(12) Patent Application Publication
(10) Pub. No.: US 2004/0249692 A1
(43) Pub. Date: Dec. 9, 2004

(54) Unit level ammunition management information system

(76) Inventor: Marco Julio Barrera, Columbus, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/726,999

(22) Filed: Dec. 3, 2003

Related U.S. Application Data
(60) Provisional application No. 60/430,598, filed on Dec. 3, 2002.

(51) Int. Cl. G06F 17/60

(52) U.S. Cl. 705/8

(57) ABSTRACT

The present invention in its preferred embodiment is a generally a computer-based system for management of ammunition for military units that improves the efficiency of ammunition management at the unit level, brigade and therebelow. The currently used system, which is a paper-based system is replaced by the present invention, thus streamlining and automating ammunition management. The present invention is particularly simple and easy to use and it increases the productivity of ammunition managers. The present invention permits accurate forecasting, allocating, requesting and distribution of ammunition resources and is able to accommodate changes in training priorities. It reduces man hours needed to forecast ammunition requirements from hours and days down to seconds and is highly accurate in record keeping and it integrates operational and logistical processes into one end-to-end system. The present invention minimizes cost to the consumers of ammunition, namely the operational unit, and thus reduces training costs.

### CROSS-REFERENCES TO RELATED APPLICATIONS

This non-provisional application claims priority to, and the full benefit of, Provisional Application No. 60/430,598, filed Dec. 3, 2002, entitled “Unit Level Ammunition Management Information System”.

### COPYRIGHT NOTICE AND LIMITED AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present invention relates generally to an apparatus, system and method for management of ammunition logistics as utilized by military units at the brigade through company level. More particularly, the present invention relates to a computer-based database system and program, typically stored on a computer storage medium, for solution and optimization of complex operational and logistical problems, leading to effective management of resources for operations and training, including procurement costs, timing and recovery at the military unit level.

### BACKGROUND OF THE INVENTION

In the course of military training and operations, it is necessary to supply troops with ammunition. Logistical management is often a primary concern in times of conflict, and is also necessary for training purposes. Many battles in history have been lost or won because of inferior or superior logistical support for the fighting troops. It is critical that ammunition is delivered to allow troops to continue to fight. Accordingly, management of ammunition for training purposes serves the dual needs of providing for training and ensuring that logistical systems are present in time of conflict.

During training, as in conflict, providing troops with the correct type and quantity of ammunition is crucial. Additionally, the recovery of unexpended ammunition serves to reduce costs and promote safety. Effectively managing and thus reducing ammunition cost, has a further benefit in that more ammunition, and hence more training, will be available for the same budgetary requirements.

Throughout history, various methods have been implemented for the management of logistics. Many such methods are often a result of trial-and-error, applied to a field of art in which there is no margin for error. More commonly utilized are paper transmittals detailing ammunition/logistical requirements and quantities supplied. However, use of paper transmittals has resulted in military logistical support involving a large amount of “paper shuffling”.

Additionally, the current paper-based system is extremely inefficient, as it is over two decades old, and, due to voluminous amounts of paper, requires significant man-hours to search through the papers and answer resource management inquiries. Moreover, the paper-based system is not integrated with other systems of management, and further produces inaccurate, inconsistent and unreliable results. Furthermore, because military personnel are typically posted for periods of only a few months, by the time users learn the paper-based system, they are rotated out to a different post, thereby requiring training of new personnel and thus, contributing to significant training costs.

In addition, each military installation has its own unique procedures for how ammunition users are to request and manage ammunition, thereby further hindering efficiency of the overall process.

Although the Army provides customer organizations (i.e., training units) with information systems, each system is provided by a different agency within the Army. As such, many of these systems are incompatible with each other, thus leaving the customer “stranded” when he/she attempts to integrate each system.

Accordingly, there is a need for an easy-to-use computer-based system that tracks requirements and matches them with warehouse supplies and transportation methods for moving product to the end-user (i.e., the military unit) in a timely and cost effective fashion.

There is a further need to improve efficiency of ammunition management at the unit level by developing an ammunition management application, wherein all information and processes function at the unit level, thus streamlining the current system through business process reengineering and subsequently automating same.

### BRIEF SUMMARY OF THE INVENTION

Briefly described, the present invention overcomes the above-mentioned disadvantages and meets the recognized need for such a device by providing a method and apparatus for managing the logistics of ammunition supply and recovery. The present invention has shown improved efficiency over existing systems, wherein users obtain results in seconds with the present invention versus hours with the existing system.

The present invention permits all required processes and information at the unit level to be integrated into one system, including, without limitation, operations, logistics, and personnel functions.

At the company level, the training plan, resource request, and hand receipt for those resources are all the same entity. Prior methods required filling-out separate requests and hand-receipts, thus creating extra (unnecessary) work. Implementation of the present method only requires the customer to plan training, while other processes utilizing information technology can retrieve required information from the training plan.

According to its major aspects and broadly stated, the present invention in its preferred embodiment is a computer-based system for management of ammunition for military units.

More specifically, the present invention is a computer program that takes user input of selected weapons training events and locates the required resources to carry out the training events. Ammunition is managed through type, quantity and selection of source, either within the unit or from outside units, and further manages the recovery of unspent ammunition, casing materials and packaging.

A feature and advantage of the present invention is that it improves the efficiency of ammunition management at the unit level.

A feature and advantage of the present invention is its integration with training management systems at the unit level.

A feature and advantage of the present invention is that implementation of same need not incur any costs to customers or require system changes.

A feature and advantage of the present invention is that it streamlines and automates current systems for management of ammunition at the unit level.

An additional feature and advantage of the present invention is that it replaces current paper-based systems.

A feature and advantage of the present invention is its simplicity and ease of use.

A further feature and advantage of the present invention is that it permits accurate forecasting, allocating, requesting and distribution of ammunition resources.

A feature and advantage of the present invention is its ability to accommodate changes in training priorities.

A further feature and advantage of the present invention is that it reduces manhours needed to forecast ammunition requirements from hours and days down to seconds.

A further feature and advantage of the present invention is that it is highly accurate in record keeping.

A feature and advantage of the present invention is its immediate and accurate visibility.

A further feature and advantage of the present invention is that it integrates operational and logistical processes into one end-to-end system.

An additional feature and advantage of the present invention is that it increases the productivity of ammunition managers.

Another feature and advantage of the present invention is that it minimizes cost to the consumers of ammunition, namely the operational unit.

A further feature and advantage of the present invention is that it reduces training costs.

These and other features and advantages of the present invention will become more apparent to one skilled in the art from the following description and claims when read in light of the accompanying drawings.

### BRIEF DESCRIPTION OF THE DRAWINGS

Having thus described the invention in general terms, the present invention will be better understood by reading the Detailed Description of the Preferred and Alternate Embodiments with reference to the accompanying drawing figures, which are not necessarily drawn to scale, and in which like reference numerals denote similar structures and refer to like elements throughout, and in which:

FIG. 1 is a chart showing the organizational structure of, and relationships between, the management and users of ammunition, according to a preferred embodiment of the present invention;

FIG. 2. shows a graphical user interface of a preferred embodiment of the present invention;

FIG. 3 is a diagram of the process for forecasting, allocating, requesting and distributing ammunition of the present invention, according to a preferred embodiment of the present invention;

FIG. 4 shows a graphical user interface of a preferred embodiment of the present invention;

FIG. 5 shows a graphical user interface of a preferred embodiment of the present invention;

FIGS. 6A-6E illustrate a program flow according to a preferred embodiment of the present invention;

FIGS. 7A and 7B show an entity relationship diagram according to a preferred embodiment of the present invention; and

FIG. 8 depicts data flow in the form of a diagram.

### DETAILED DESCRIPTION OF THE PREFERRED AND SELECTED ALTERNATE EMBODIMENTS

In describing the preferred and selected alternate embodiments of the present invention, as illustrated in the Figures, specific terminology is employed for the sake of clarity. The invention, however, is not intended to be limited to the specific terminology so selected, and it is to be understood that each specific element includes all technical equivalents that operate in a similar manner to accomplish similar functions.

The present invention is suitable for managing ammunition accounts, matching requisitions with forecasts, and calculating the logistics paths required for carrying out the supply of ammunition.

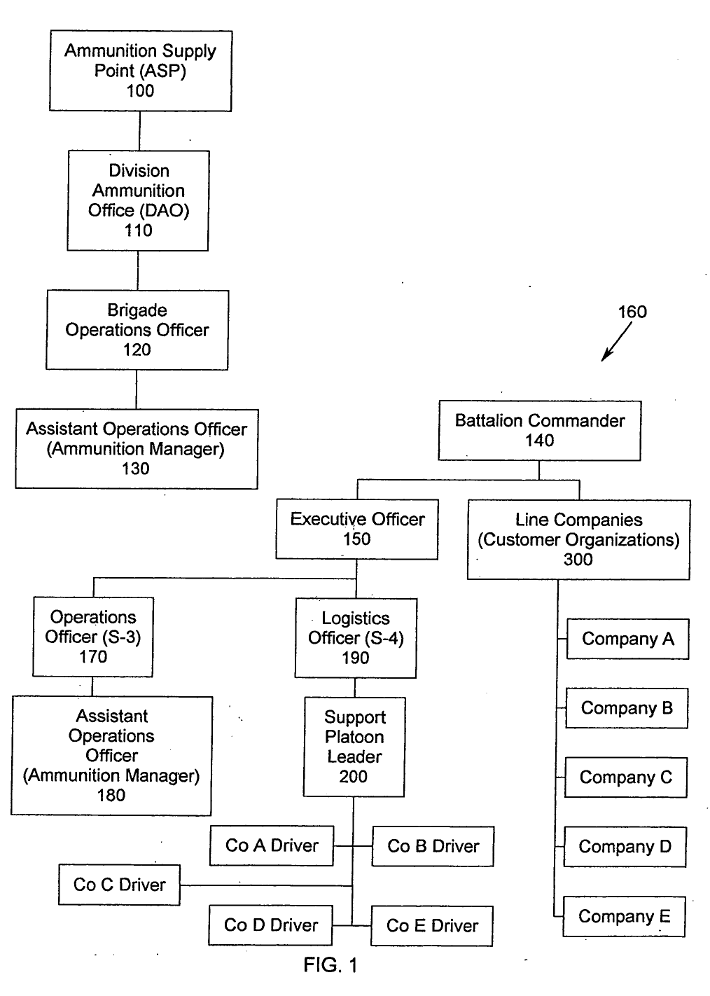

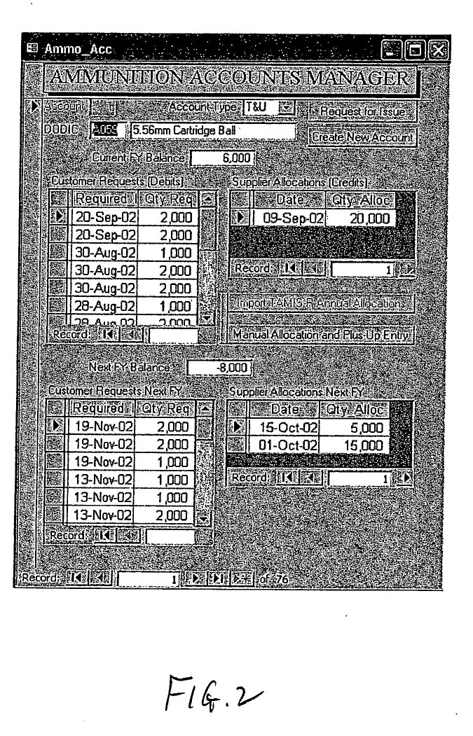

Referring now to FIG. 1, division ammunition office manager 110 and brigade operations officer 120 receive forecast orders from battalions 160 and allocate ammunition resources based on priorities for training. Preferably, battalion commander 140 and his executive officer 150 are the system owners. Battalion operations officer 170 and his assistant 180, the latter of which is responsible for management of ammunition for battalion 160, are system users who receive requests for ammunition from line companies (customer organizations) and subsequently process the requests into formal forecasts as depicted in FIG. 2, wherein FIG. 2 illustrates the graphical user interface of the ammunition accounts manager program 185. Battalion operations officer 170 and his assistant 180 preferably forecast and allocate training ammunition and manage allocation accounts for each type of ammunition used by battalion 160. Logistics officer 190, and his assistant, support platoon leader 200 preferably manage physical inventory and distribution. Line companies 300 are the actual customers who conduct unit training, and thus consume the ammunition products.

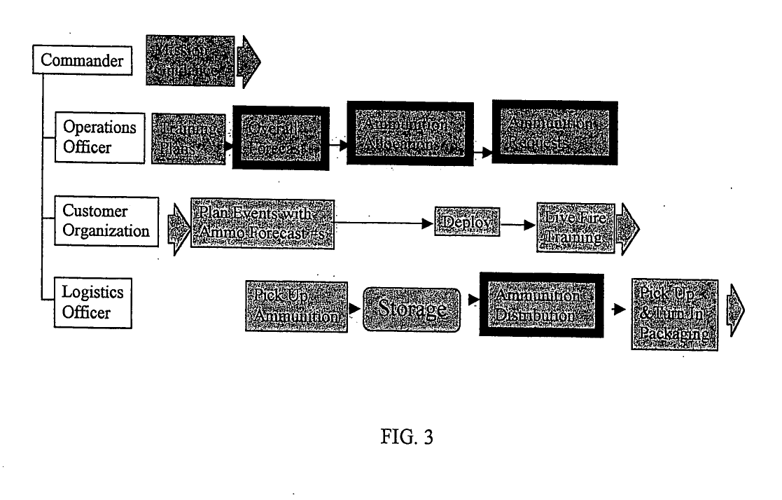

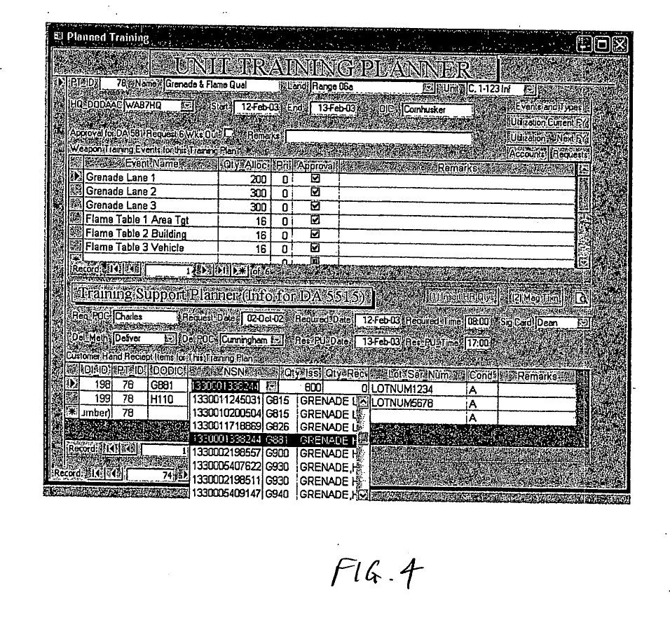

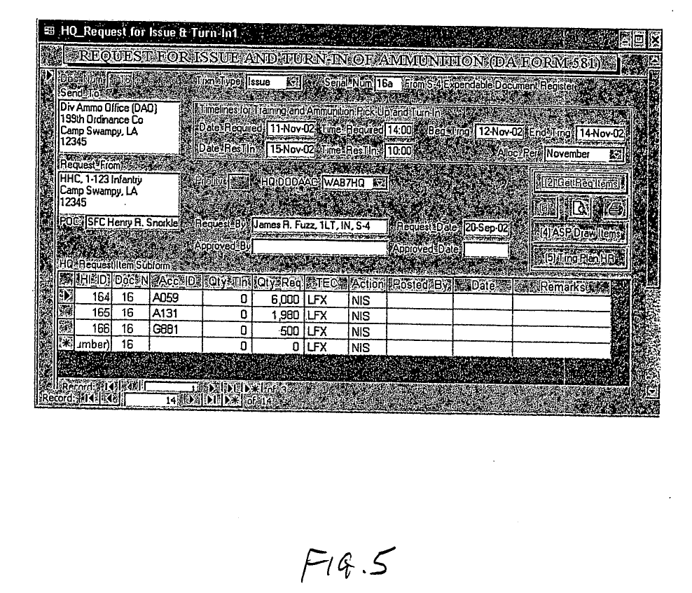

FIG. 3 shows system processes for ammunition forecasts from customers up through organizational hierarchy. Division ammunition office manager 110 preferably compiles forecasts from many organizations and allocates ammunition resources based on availability and unit priorities. Brigade and battalion ammunition managers 120 and 180, respectively, further allocate the ammunition resources to end-users according to end-users annual allocations. End-users must forecast ammunition based on training plans within specified time constraints as shown in FIG. 4, the unit training planner 195. Based on such forecasts, end-users then request ammunition against their allocations through the organizational hierarchy 160. Division ammunition manager 110 preferably controls allocations for brigades and schedules physical distribution to end-users, Wherein end users preferably alter training plans if allocated quantities fall short of those requested. Logistical officer 190 preferably transports and stores ammunition for consumption by the end-users. When an end-user completes his/her training, Logistical officer 190 retrieves and turns in packaging material and unused ammunition in accordance with a Request for Issue and Turn-in of Ammunition DA Form 581 as depicted in FIG. 5.

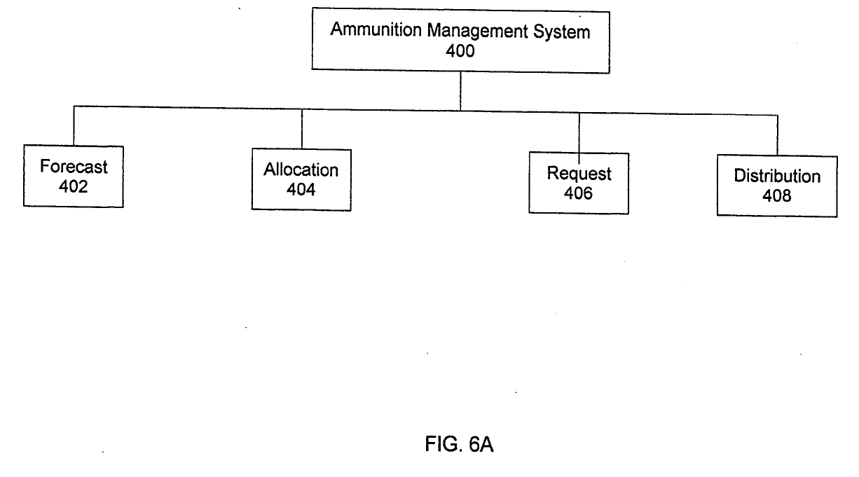

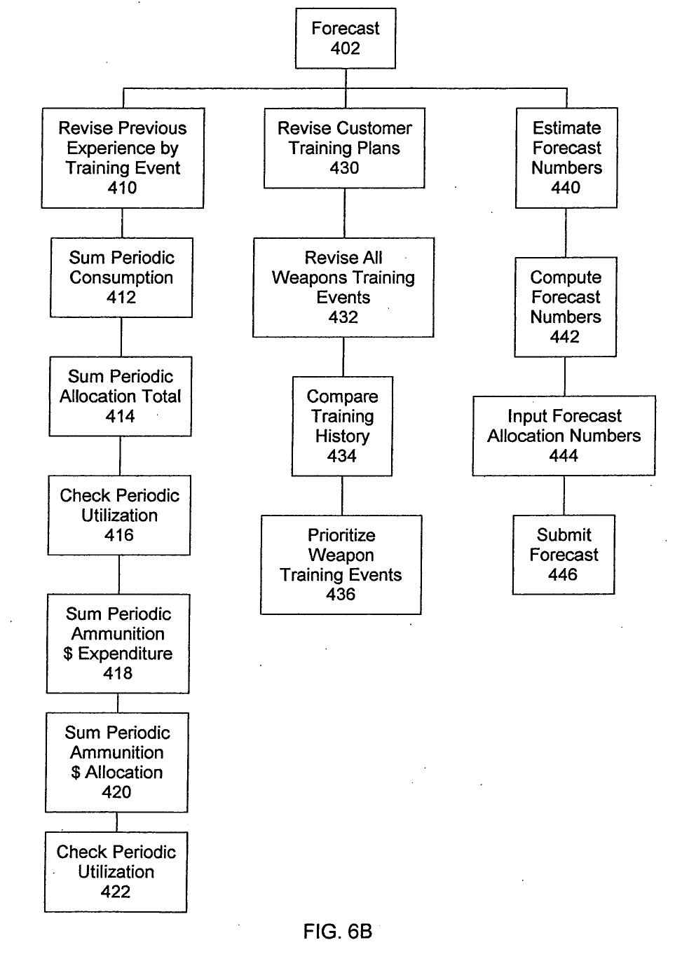

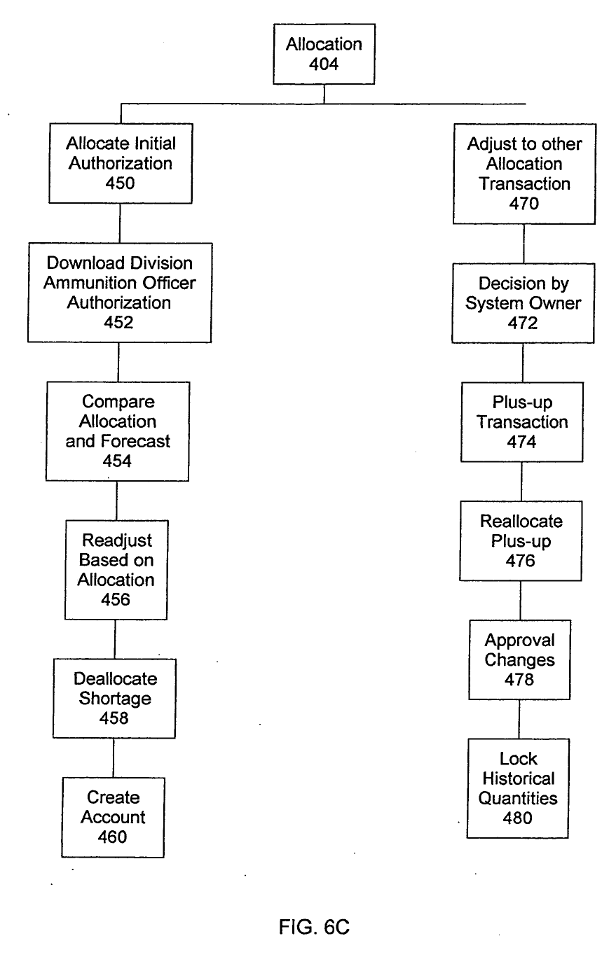

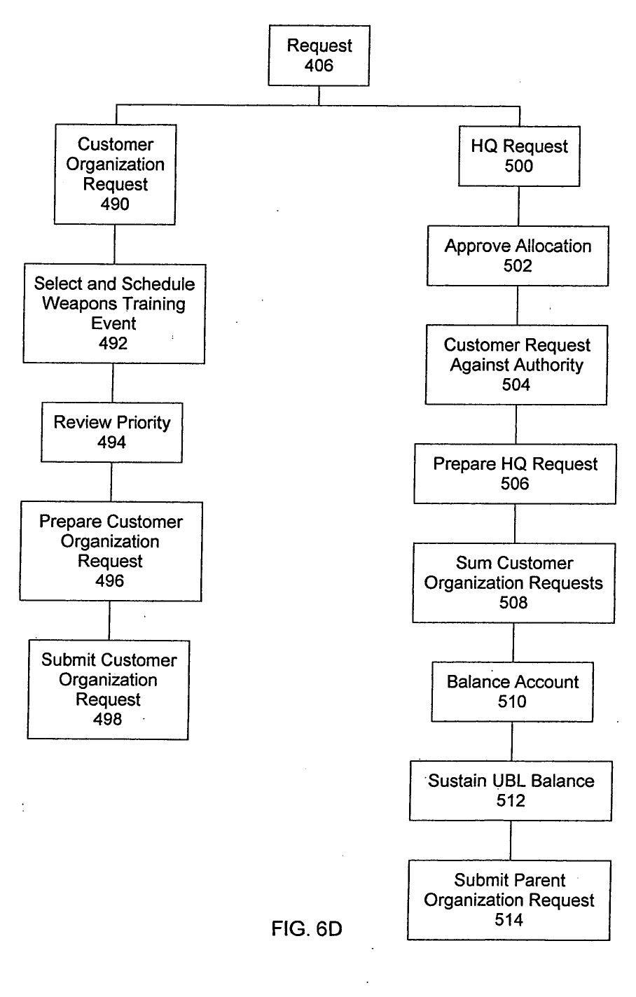

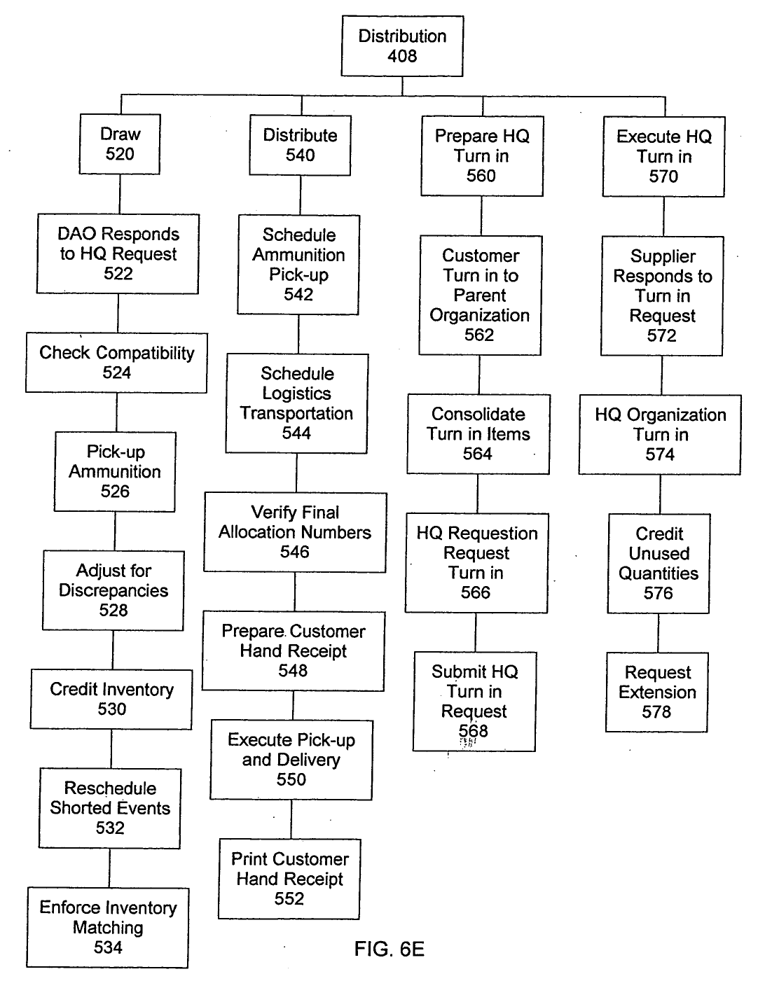

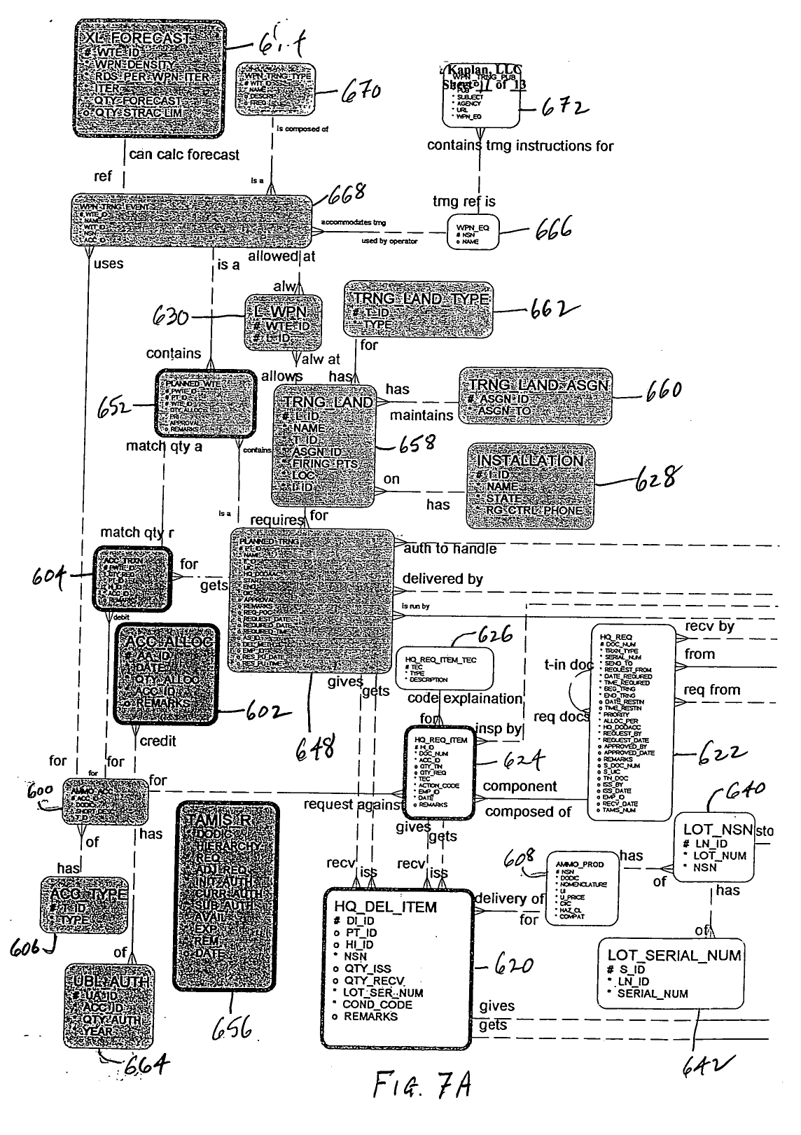

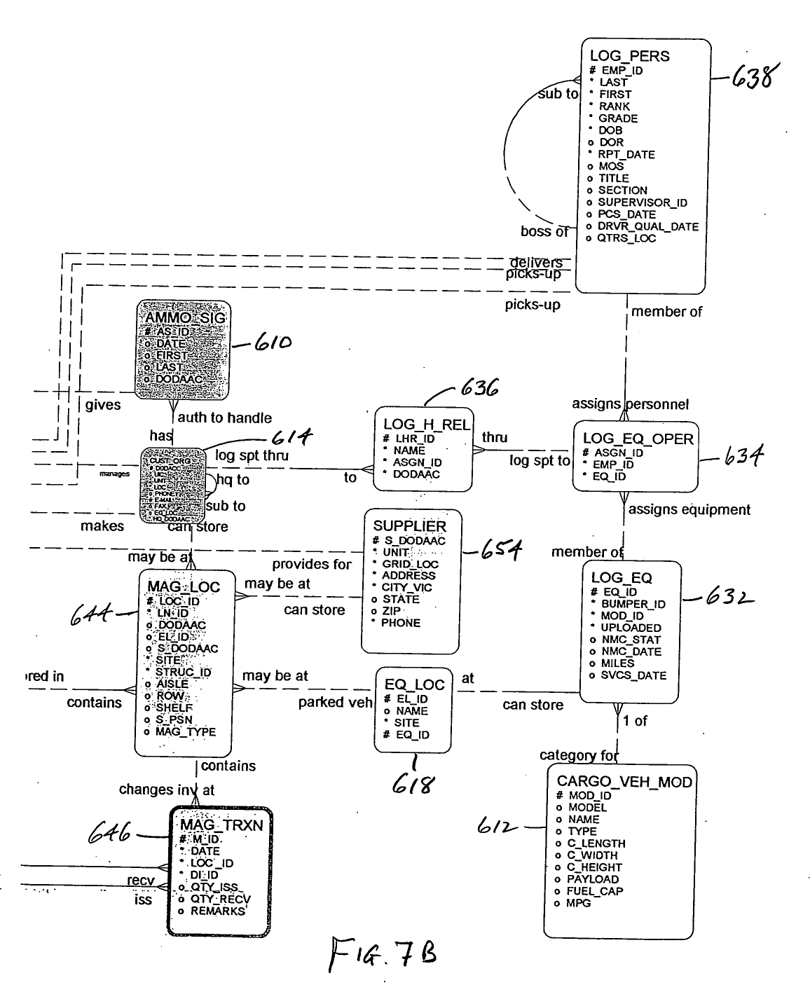

The ammunition management information system of the present invention is implemented at a functional level through a database management program, structured query language, embedded-code forms, wherein the forms have named tables and fields therein, and software computation and matching functions, as is shown in FIGS. 6A-6E, 7A, and 7B.

Referring now to FIG. 6A, ammunition management system 400 provides an accounting system for all functions, namely forecasting, requesting, allocating and distributing. Ammunition management system 400 preferably utilizes four principal functional spheres to provide the allocation of ammunition to user level units. The first of these four functional spheres is forecast 402, wherein forecasts are preferably made against training requirements on a fiscal year and quarterly basis. The second sphere is allocation 404, wherein division training officer, such as for exemplary purposes only, executive officer 150, through division ammunition officer (DAO) 110 (see FIG. 1) preferably annually allocates training ammunition, and makes ammunition quantity adjustments quarterly, weekly and daily for training events. Once ammunition enters physical inventory, allocations may changed at any point. The third functional sphere is request 406, wherein parent organization, such as, for exemplary purposes only, battalion 140, preferably consolidates customer requests onto one request and forwards same through approval authority to DAO 110 (See FIG. 1). The fourth sphere is distribution 408, wherein an accounting is made for physical distribution of ammunition and packaging material.

Referring now more specifically to FIG. 6B, forecast 402 is described in more detail. In step 410, historical expenditures for previous comparable training events are reviewed, wherein the amount of demand each training event is likely to produce is determined. Step 410 preferably triggers steps 412 through 422. In step 412, consumption is summed by Department of Defense Identification Code (DODIC) for both the previous fiscal year and the current fiscal year to date. In step 414, allocation totals are preferably summed by DODIC for both the previous fiscal year and the current fiscal year to date. In step 416, periodic utilization is preferably computed and compared to 95% of the previous fiscal year total, wherein an associated report is subsequently produced. In step 418, dollar expenditures are preferably summed for each DODIC utilizing the average unit price from respective national stock numbered (NSN) items consumed for both the previous fiscal year and the current fiscal year to date. In step 420, dollar expenditure is preferably totaled for each DODIC allocated for both the previous fiscal year and the current fiscal year to date. In step 422, periodic allocation and utilization is preferably computed and compared to 98% of the previous fiscal year's total, wherein an associated report is subsequently produced by this step.

Step 430 preferably triggers steps 432 through 436, wherein customer organization plans are reviewed for the upcoming fiscal year. In step 432, all planned training and planned weapon training events for all customer organizations are preferably reviewed for the current fiscal years, wherein human input is preferably utilized step 432, and wherein an associated report is subsequently produced. In step 434, each planned weapon training event is preferably compared to its historical instances, wherein human input is preferably utilized during step 434. In step 436, all approved planned weapon training events across all organizations are preferably prioritized for a given time frame, wherein human input is preferably utilized during step 436.

In step 440, forecasts or estimated usage computation and Standards in Training Commission (STRAC) limits are preferably determined utilizing historical data. In step 442, the number of rounds of ammunition is computed and/or copied, from previous training events. In step 444, a number for each approved weapon training event is preferably input. In step 446, forecast 402 is submitted to DAO 110 (See FIG. 1), through approval authority, no later than six months prior to beginning of the fiscal year and no later than the first of each month with a projection of ninety training days. DAO 110 (See FIG. 1) is notified preferably by email that forecast 402 is complete.

Referring now more specifically to FIG. 6C, allocation 404 is described in more detail. In step 450, headquarters organization, such as, for exemplary purposes only, battalion 140, divides its annual allocation by preferably allocating quantities to each planned weapon training event. In step 452, DAO 110 (See FIG. 1) responds to annual forecast 402 from headquarters organization with annual authorization allocations, preferably in an EXCEL™ spreadsheet from Training Ammunition Management Information System Revised (TAMIS_R). Automated input is preferably utilized during step 452, but human input may be selectively utilized. (TAMIS_R presents the user with an interface to enter total requested ammunition quantities. A future planned TAMIS system allows the user to enter ammunition quantities and track orders online via a global networking system, such as, for exemplary purposes only, the Internet. TAMIS_R meets only requirements 514 and 522 on FIGS. 6D and 6E below.) This step triggers step 454. In step 454, allocations and forecasts are compared for each DODIC. If allocation is greater than forecast, then allocation is complete. In step 456, if allocation is less than forecast, a review of all planned weapon training events of customer organizations is preferably conducted and an order of priority is preferably determined for the fiscal year, or if less than a fiscal year, for the remaining portion thereof, wherein an associated report is subsequently produced. Preferably step 456 triggers step 458. In step 458, lower priority events are de-allocated for the given time frame, which zeroes-out allocations against planned weapon training events. In step 460, an account is created, if necessary, for balancing allocations.

In step 470, headquarters organization can gain or lose quantity increments against ammunition accounts for numerous reasons, the occurrence of which requires adjustments to allocations for planned weapon training events. In step 472, to accommodate for ammunition shortage, a decision is preferably made by system owner 140, 150 and/or 300 to request “plus-up” (i.e., an increase) to cover shortages, adjust priorities for planned training events and/or reallocate ammunition from other training events. Human input is preferably utilized during step 472. In step 474, supplier organization, such as, for exemplary purposes only, DAO 110, preferably issues a credit (deposit) into headquarters organizations' ammunition accounts, wherein human input is preferably utilized during step 474. Step 474 preferably triggers step 476, wherein entire plus-up is reallocated to provide ammunition quantities to the planned weapon training events of the highest priority that are short of allocations. In step 478, the plus-up changes are submitted for approval. In step 480, historical quantities are locked, and no updates to same are permitted. Additionally, updates to allocations, requests, and distributions are prohibited once becoming historical.

Referring now more specifically to FIG. 6D, request 406 is described in more detail.

In step 490, training plans generate training requests against training events preferably no later than the following seven weeks. In step 492, customer organization 300 preferably selects and schedules weapon training events, wherein human input is utilized during step 492. In step 494, quarterly training brief is reviewed for training priorities. Training priority may be altered by guidance from system owner 140/150. Human input is preferably utilized during step 494, wherein a report associated with step 494 is issued. In step 496, customer organization 300 preferably prepares ammunition requests for each planned weapon training event, wherein human input is also preferably utilized during step 496. In step 498, customer organization 300 preferably submits planned ammunition request to parent organization 140 no later than seven weeks prior to a planned training event. Customer organization preferably sends email to headquarters providing notification of completion of requests.

In step 500, headquarters generates request for ammunition no later than six weeks prior to a planned weapon training event, wherein the occurrence of each event preferably triggers a subsequent following event. In step 502, system owner 140/150 preferably approves the ammunition allocations. Human input is further preferably utilized during step 502. In step 504, allocation numbers are preferably approved. In step 506, Battalion ammunition manager 180 (See FIG. 1) preferably prepares ammunition requests. Each headquarters organization request rolls up customer organization requests totals by DODIC for a given time frame. Human input is preferably utilized during step 506. In step 508, customer request lines are preferably summed by DODIC six weeks prior to a weapons training event. In step 510, account manager, such as, for exemplary purposes only ammunition manager 130 preferably views sums by DODIC in real time for the current and the next fiscal year. In step 512, account manager is warned if utilization depletes accounts below unit basic load (UBL) levels. In step 514, battalion ammunition manager 180 (See FIG. 1) submits ammunition request through approval authority to DAO 110 (See FIG. 1) six weeks prior to a planned weapons training event. DAO 110 is preferably sent a confirmation email upon completion of request information.

Referring now more specifically to FIG. 6E, distribution 408 is described in more detail. In step 520, headquarters' logistics organization 190 picks up ammunition products from supplier organization and debits or credits inventory. In step 522, DAO 110 (See FIG. 1) preferably returns each headquarters organization request with distribution information, including, without limitation, unique document number, draw date, time location and quantities. Human input is preferably utilized during step 522. In step 524, compatibility of products on request is checked. In step 526, ammunition is inventoried at supplier organization. Quantities are verified by lot and serial number on accountability documentation or interface, wherein human input is preferably utilized during step 526. In step 528, if physical quantities on hand are less than requested, readjustments, de-allocations or rescheduling preferably occurs in accordance with steps 454, 456 and 458 of FIG. 6C, wherein an associated report is subsequently issued. In step 530, inventory is credited for receipts. Human input is preferably utilized during step 530. In step 532, if allocation is unchanged, shorted planned weapon training events can be rescheduled, wherein other weapons training events can be scheduled accordingly. Human input is preferably utilized during step 532. In step 534, inventory matching is preferably enforced. Additionally, associated with step 534 is issued.

In step 540, retrieval of is scheduled with customer organization 300 and a hand receipt showing ammunition delivered is provided to customer organization for training events. In step 542, ammunition pick-up or drop-off is preferably scheduled between HQ organization and customer organization. Human input is preferably utilized during step 542. In step 544, logistics transportation is scheduled, wherein human input is preferably utilized during step 544. In step 546, headquarters logistics organization preferably verifies final allocation numbers and signature card holders of customer organization. Human input is preferably utilized during step 546. In step 548, hand receipt information is preferably entered for ammunition and packaging material required for turn-in. Human input is preferably utilized during step 548. In step 550, customer organization 300 preferably picks up ammunition from the headquarters logistical site, or headquarters logistics personnel and/or equipment deliver the ammunition to customer organization 300. Human input is preferably utilized during step 550. In step 552, customer hand receipts are preferably printed.

Preferably, in step 560, customer organizations prepare to turn-in packaging and unused items to the parent organization in order to clear hand receipts. In step 562, packaging and unused items are preferably turned in by verifying and entering unused quantities and packaging materials, wherein customer hand receipts are subsequently cleared. Human input is preferably utilized during step 560. In step 564, headquarters organization consolidates and groups like items, unused items, packaging and brass, weighs brass and links, and compares brass and link weight to that required for turn-in. In the event of any discrepancy of brass and link, a memo is prepared for write-off, wherein human input is preferably utilized during step 564. In step 566, headquarters organization sums brass and links and ammunition by DODIC for turn-in. Similar packaging materials are summed for turn-in, and quantities of ammunition, brass, links, and packaging materials are entered for turn-in. In step 568, the turn-in request is submitted through approval authority to DAO 110 (See FIG. 1).

In step 570, packaging and unused products are turned in. In step 572, supplier responds to headquarters organization request with turn-in information, including, without limitation, unique document number, turn-in date, time and location, wherein human input is preferably utilized during step 570. In step 574, headquarters organization turns in residual packaging and live ammunition to the supply point, wherein a debit is made to inventory. Human input is preferably utilized during step 574. In step 576, unused quantities are credited to ammunition accounts, wherein human input is preferably utilized during step 576. In step 578, an extension may be requested when lengthy training events make it inconvenient for headquarters organization to meet turn-in deadlines.

In carrying out the various steps of the program as described above, it is advantageous to understand the relationships between the many variables or entities utilized in the calculations. Accordingly, with reference to FIGS. 7A and 7B, which collectively form the Entity Relationship Diagram (ERD), such relationships are readily understood.

The Entity Relationship Diagram (ERD) of FIGS. 7A and 7B preferably represents user requirements for data and information, and further defines the functions of the present program. The diagrams of FIGS. 7A and 7B are also referred to as conceptual models or data models. The ERD becomes the blueprint for a database design.

Entity Definitions:

© 2002, Marco J. Barrera

Ammunition Account (Ammo_Acc) 600: Maintains account for an ammunition item authorized for use by customer organization. Ammunition Account 600 represents a single line, double entry accounting system with debits (Qty_Req) and credits (Qty_Alloc) further normalized into separate entities. A Department of Defense Identification Code (DODIC) uniquely identifies each of the ammunition items. A short description (Short_Desc) helps system user identify the ammunition items.

Ammunition Account Allocation (Acc_Alloc) 602: This entity represents half of the accounting system for ammunition resource management. Account transactions represent the remaining half. The quantity allocated (Qty_Alloc) is a credit (scheduled deposit) transaction against an ammunition account from supplier (external entity). A query inserts required data after extracting it from a supplier's data in TAMIS_R table. Date attribute represents the date that an allocation is available for requesting.

Ammunition Account Transaction (Acc_Trxn) 604: This entity represents half of the accounting system for ammunition resource management, wherein account allocations represent the remaining half. Quantity requested (Qty_Req) is a debit (scheduled withdrawal) transaction against an ammunition account. Each instance can be a future (pending) transaction or an historical transaction depending on the transaction date. All quantity requested transactions that support requirements for start and end date times for one instance of a customer's planned training are consolidated onto one customer request.

From the standpoint of customer requests, account transaction entity can also be viewed as customer request item (Cust_Req_Item).

Ammunition Account Type (Acc_Type) 606: Some organizations must separate training ammunition from unit basic load (UBL) inventories. Faced with this condition of separating ammunition types, customer organization maintains separate account types for each. Some organizations that maintain UBL inventories can mix both UBL and training ammunition so long as the organizations maintain balances above their UBL requirements. Under such a mixed condition, the organizations use first in-first out (FIFO) accounting to consume oldest inventory first and maintain newest inventory for contingencies.

Ammunition Product (Ammo_Prod) 608: This entity represents a catalog containing detailed information about each ammunition product that exists. It contains more attributes than shown in the present ERD. Ammunition Product 608 is an external agent maintained by Logistics Support Agency (LOGSA). Multiple National Stock Numbers (NSNs) can exist for each Department of Defense Identification Code (DODIC). Other useful information includes unit prices, and weights and dimensions for palletized loads.

Ammunition Signature Card (Ammo_Sig) 610: Identifies personnel in each customer organization who are authorized to handle ammunition. Authorization requires passing a certification course. Support platoon maintains a list of certified customer personnel and certification expiration dates.

Cargo Vehicle Model (Cargo_Veh_Mod) 612: Important information requirements of this entity are cargo dimensions (C_Length, C_Width, & C_Height) and payload utilized to plan movement of ammunition or other supplies. The present invention and/or logistical personnel can compare vehicle cargo dimensions, compatibility with weapons and hazard class, and payload against ammunition pallet load dimensions and pallet weights contained in ammunition products (Ammo_Prod) 608 entity and thereby determine the types and number of vehicles required.

Customer Organization (Cust_Org) 614: Lowest level organization that plans and executes training and submits a request for ammunition for each instance of planned training. System owner (parent organization) 140/150 determines who acts as a customer. Typical customer organization is a company, battery, or specialty platoon. In this recursive entity, some customer organizations are also headquarters for other customer organizations.

HQ Organization (HQ_Org) (superceded by Customer Organization (Cust_Org) 614 above: Headquarters for a group of customer organizations. It has allocation authority over its customer organizations. It is the lowest level organization that has an ammunition account with suppliers. It is also the lowest level organization that owns logistical personnel and transportation assets and possibly storage facilities to manage physical ammunition inventories. An ammunition management information system provides its greatest efficiency when utilized at highest level of organizational hierarchy containing like customer organizations. Headquarters organization is most likely a battalion, but can be a brigade or regiment.

Equipment Location (Eq_Loc) 618: Location of logistical equipment utilized by support platoon to provide service to customer organizations. Typical location is a parking space in a motor pool. Trucks and trailers for cargo, fuel, and water make up most of the logistical equipment.

Headquarters Organization Delivery Item (HQ_Del_Item) 620: Tracks quantities received (Qty_Rec) into organization's inventory stores, and further tracks quantities issued (Qty_Iss) out of those stores. Transactions take place between external suppliers and inventory or internal customer organizations and inventory. Entity 620 facilitates recording national stock numbers (NSNs) and lot numbers for each delivery item. Each HQ delivery item line can be dispersed into multiple magazine locations.

Headquarters Organization Request (HQ_Req) 622: An instance of this entity contains information for a complete ammunition package for pick-up and/or turn-in between headquarters organization's logistical organization and supplier organization. One headquarters organization's request for draw consolidates multiple customer organization requests for a given time frame. A request for turn-in consolidates packaging materials and unused ammunition items from multiple headquarters organization requests. This request delivers information required by the supplier organization on Department of the Army (DA) Form 581. Each headquarters Request can contain multiple line items—one for each product.

Headquarters Organization Request Item (HQ_Req_Item) 624: An instance of this entity consolidates customer request items (Acc_Trxn.Qty_Req lines) for one ammunition item for a given time frame. Each headquarters organization request item is one of multiple lines on one headquarters organization request. One headquarters request item can receive products of multiple lot national stock numbers, lot numbers, or serial numbers.

Headquarters Organization Request Item Training Event Code (HQ_Req_Item_TEC) 626: This entity contains detailed look-up data to assist a user in selecting appropriate Training Event Codes (TECs) while creating records for HQ Rec_Item table.

Installation 628: Tracks military installations that have weapon training facilities utilized by customer organization. A customer organization may utilize training facilities at more than one installation.

Land Weapon Combination (L_WPN) 630: Specific ranges and training areas typically allow use of only certain weapons and munitions. This entity contains valid combinations for allowable munitions usage for each range.

Logistical Equipment (Log_Eq) 632: Logistical equipment utilized by support platoon to provide service to customer organizations. Trucks and trailers for cargo, fuel, and water make up most of this equipment.

Logistical Equipment Operator (Log_Eq_Oper) 634: Logistical (support platoon) personnel assigned responsibility for logistical equipment. Each operator normally maintains his assigned equipment and operates it to provide logistical support to the customer organization to which the operator is habitually assigned.

Logistical Habitual Relationship (Log_H_Rel) 636: The support platoon leader can assign specific logistical personnel and vehicles to form habitual relationships to specific customer organizations. This arrangement is comparable to customer relationship management. These logistical personnel include ammunition and fuel specialists who will learn and adapt to their customer organization's specific operating methods and procedures.

Logistical Personnel (Log_Pers) 638: This entity tracks personnel information for logistical personnel (support platoon).

Lot Number—National Stock Number (Lot_NSN) 640: Tracks lot numbers of products delivered to inventory. Each product (DODIC) can have multiple national stock numbers. Each NSN can have multiple lot numbers. Manufacturers affix lot numbers to track production lots. Government may recall an entire lot if some units are found defective. Logistical organization creates magazine locations to segregate products by lot number.

Lot Serial Number (Lot_Serial_Num) 642: Tracks serial numbers of a given product lot delivered to inventory when applicable. Individual units of certain products are identified by a unique serial number.

Magazine Location (Mag_Loc) 644: Identifies location of an ammunition magazine. Attributes utilized identify site and structure identification of each magazine, and identify locations within a structure. Short timeline for distribution can require storage of like ammunition items in multiple locations. Products are positioned in prepackaged configurations for immediate distribution to customers. This attribute has subtypes that include facilities of customers (Cust_Org) and supplier storage facilities, and uploaded logistical vehicles (Eq_Loc).

Magazine Transaction (Mag_Trxn) 646: Magazine is a physical storage location containing like items. This entity records quantities issued (Qty_Iss), (i.e., debits), and quantities received (Qty_Rec) (i.e., credits), for individual magazines.

Planned Training (Planned_Trng) 648: Instance of this entity includes all training events within one defined start date/time and end date/time as determined by customer organization. This instance includes all weapon planned training events that can be supported by one delivery to one location on one customer request and/or hand receipt). A single location might serve as a temporary ammunition supply point (field ASP) to accommodate training at multiple locations in close proximity. The training plan of the customer organization in this design serves at least four purposes:

1. Communicate a training plan

2. Serve as the request for ammunition resources for that plan

3. Serve as the hand receipt and turn-in document for physical distribution of ammunition.

4. Schedule delivery and pick-up by logistical personnel and equipment.

In comparison to a retail system, the training plan (PLANNED_TRNG) can be viewed as the subordinate unit's invoice. Related planned weapon training events (PLANNED_WTE instances) can be viewed as the invoice item lines that reflect the subordinate unit's unrestricted requirements. Related account transactions (ACC_TRXN instances) can be viewed as invoice item lines from (PLANNED_WTE) that reflect approval and commitment by the parent headquarters prior to submission of an official request (currently a DA FORM 581). This approval process involves screening and approving individual training events in subordinate units' plans to ensure that forward account balances do not exceed annual authorizations.

Planned Weapon Training Event (Planned_WTE) 652: Instance of this entity is a weapon-training event that a customer organization has entered onto a training calendar and eventually into a training schedule. These events require approval by system owner 140/150. Only system owner 140/150 has approval authority. Leadership can prioritize these events to facilitate management and allocation of ammunition resources. Each event requires an ammunition allocation quantity (Qty_Alloc) that matches respective forecast quantity (Qty_Forecast). Upon prioritization and approval, an allocation becomes a transaction quantity on customer's pending request. Non-availability of ammunition can result in de-allocation (reduction based on priorities) of an allocated quantity to an amount less than the organization forecast and requested. Once execution of a planned weapon training event is complete, its allocated quantity becomes its consumption quantity for historical records. This is the last entity where quantities get edited.

Supplier 654: Identifies suppliers of organization's ammunition products. Suppliers include Division ammunition offices (DAOs), ammunition supply points (ASPs) and ammunition transfer points (ATPs).

TAMIS_R 656: Contains accounts allocations downloaded from supplier's system. User downloads these data from EXCEL™ spreadsheet provided from supplier into TAMIS_R data table. This table is in the same format as the spreadsheet. Another query extracts current fiscal year allocations from TAMIS_R and converts it into a format utilized in ammunition account table for subsequent use by a customer organization.

Training Land (Trng_Land) 658: Ranges and training areas utilized to conduct training with weapons and munitions. This type of land is controlled resource that a customer organization must schedule and reserve as part of training plans.

Training Land Assignment (Trng_Land Asgn) 660: Provides look-up information on which customer organization is assigned to particular training area for upkeep.

Training Land Type (Trng_Land_Type) 662: Provides look-up information on the type of training land in training land table. Information includes equipment and munitions that customer organization can utilize on a particular type of training land.

Unit Basic Load Authorization (UBL_Auth) 664: Some organizations maintain stockpiles for all ammunition required to sustain organization through initial days of a contingency. Authorized quantities (Qty_Auth) for headquarters organization's ammunition accounts can change each year.

Weapon Equipment (Wpn_Eq) 666: Any equipment that can consume ammunition products during usage. Users frequently consult training publications (field manuals) for equipment items to obtain training guidance and forecast quantities.

Weapon Training Event (Wpn_Trng_Event) 668: Lowest subset of training event that consumes ammunition. Customer organization computes forecast for each event. Customer organization can define weapon events and types to forecast ammunition consumption for any operation.

Weapon Training Event Type (Wpn_Trng_Type) 670: Complete individual or collective task for which training consumes ammunition. Example: pistol qualification or squad maneuver live fire exercise.

Weapon Training Publication (Wpn_Trng_Pub) 672: Each weapon system has its training publications. Publications usually contain information on ammunition requirements for weapon training events. Most publications are published on a global networking system, such as, for exemplary purposes only, the Internet. Attributes include URL links.

XL_Forecast 674: This entity represents a spreadsheet maintained by each customer organization to input and compute forecast quantities (Qty_Forecast) for each weapon training event utilizing spreadsheet formulas. Each forecast quantity represents ammunition requirements for a specific weapons training event. Other attributes in this entity are factors in forecast computations. Customer organizations may also consult other references for these quantities, specifically historical data, training publications (field manuals), and STRAC publication.

© 2002, Marco J. Barrera

The ammunition management information system software includes the use of structured query language and forms with embedded code. TABLE I below sets forth a sample of the structured query language utilized to implement the present program and is a subset of the appended SQL Processes document, incorporated herein by reference.

© 2002, Marco J. Barrera

TABLE I
Product Utilization Reports (See FIG. 6B, reference numerals 412, 414, 416, 418, 420, 422).
This process requires queries on previous queries that contain outer joins. It also re-uses
components from 454 and 456 from FIG. 6C. FY Utilization Report on the Forecasts
interface is the final result.
FY Utilization Report
SELECT [Shortage Alloc].DODIC, [Shortage Alloc].Short_Desc AS [Short Description],

Nz([ShortD Usage WTE to Ammo_Acc].Usage,0) AS [Usage], [Shortage

Alloc].Alloc AS Allocation,

Format(100*NZ([Usage])/NZ([Allocation]), ″#,#0.0″) AS [% Utilization],
[Ammo Acc Unit Prices].[Avg U Price],
Format(Nz(Usage*[Ammo Acc Unit Prices].[Avg U Price],0), ″$#,##0.00″) AS [$

Usage],

Format(Nz(Allocation*[Ammo Acc Unit Prices].[Avg U Price],0), ″$#,##0.00″)

AS [$ Allocation],

Format(100*NZ([$ Usage])/NZ([$ Allocation]), ″#,#0.0″) AS [% $ Utilization]

FROM [Ammo Acc Unit Prices]INNER JOIN ([Shortage Alloc]INNER JOIN [ShortD
Usage WTE to

Ammo_Acc]ON [Shortage Alloc].Acc_ID = [ShortD Usage WTE to

Ammo_Acc].Acc_ID) ON [Ammo

Acc Unit Prices].DODIC = [ShortD Usage WTE to Ammo_Acc].DODIC;

Ammo Acc Unit Prices - used in FY Utilization Report
SELECT Ammo_Prod.DODIC, FORMAT(AVG(Ammo_Prod.U_Price), ″$#,##0.00″) AS
[Avg U Price]
FROM Ammo_Prod
WHERE DODIC IN (SELECT DODIC

FROM Ammo_Acc)

GROUP BY DODIC
ORDER BY DODIC;

© 2002, Marco J. Barrera

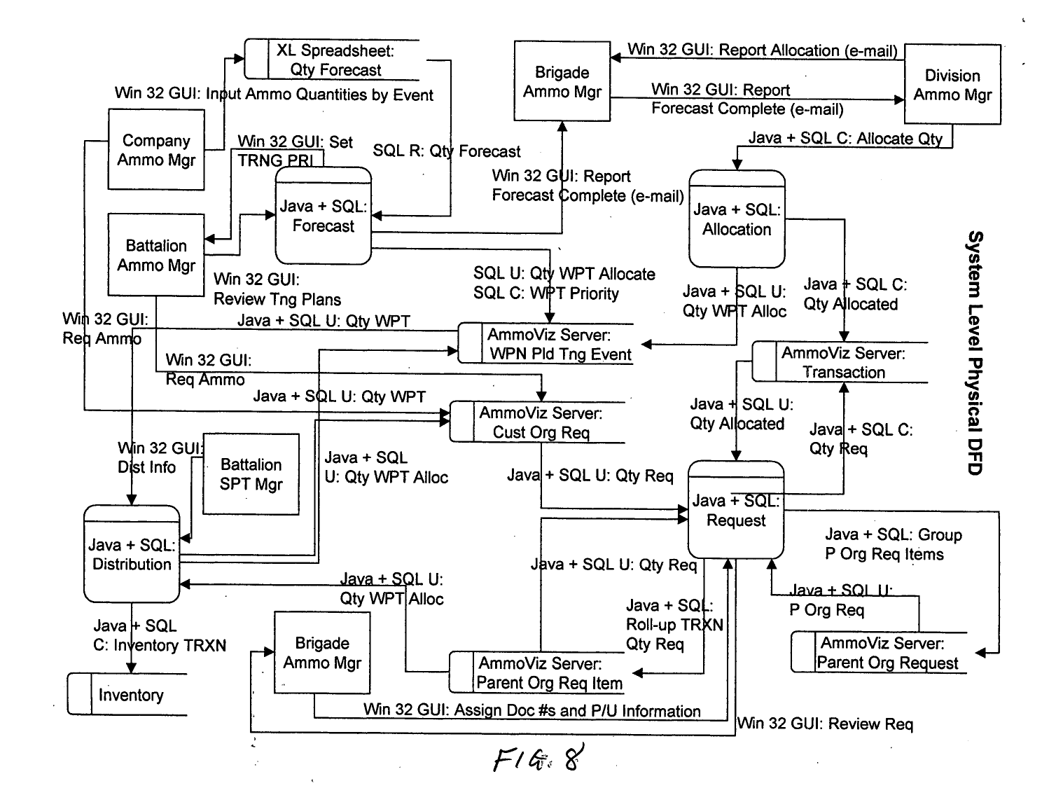

FIG. 8, a Data Flow Diagram at the System Level further describes the computer program processes and interrelationships of a preferred embodiment of the present invention.

In an alternative embodiment, the unit level system identifies all authorized substitutes for a given ammunition product.

In an alternate embodiment of the present invention, it is envisioned that a computer spreadsheet could be utilized in lieu of an EXCEL™ spreadsheet.

It is further envisioned in an alternative embodiment that the unit level system will identify all weapon equipment that can utilize a given ammunition product.

It is still further envisioned, in an alternative embodiment, that all ammunition products usable by a given weapon will be identified by the unit level system.

In yet an additional alternative embodiment, the unit level system identifies all residue packaging and/or spent casing requirements for recovery and disposal for a given ammunition product.

In still a further alternative embodiment, each storage magazine is marked with bar code labels.

In another alternative embodiment, the number and types of vehicles required to transport the ammunition requested are identified.

In a further embodiment, vehicles are identified as to hazard class and compatibility codes for requisitioned ammunition.

In another embodiment, each ammunition package is marked with a bar code label coupled with scanning equipment such that an ammunition unit manager can obtain inventory and control.

In still a further embodiment, an integrated application at division or installation level is accessible by subordinate units.

In an additional embodiment, the wholesale/retail level obtains forecast and request information from training plans of the unit level organizations.

The appended documentation, entitled “MMIS Project Proposal”, “User Requirements for the Unit Level Ammunition Management Information System”, “ENTITY DESCRIPTIONS for the Unit Level Ammunition Management Information System”, “PROCESS DESCRIPTIONS and FORMS for the Unit Level Ammunition Management Information System”, “User's Manual for Unit Level Ammunition Management Information System Desktop Edition” and “SQL Processes” is supportive of this application and is specifically incorporated herein by reference.

Having thus described exemplary embodiments of the present invention, it should be noted by those skilled in the art that the within disclosures are exemplary only, and that various other alternatives, adaptations, and modifications may be made within the scope of the present invention. Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation. Accordingly, the present invention is not limited to the specific embodiments illustrated herein, but is limited only by the following claims.

What is claimed is:

1. A method of managing ammunition for military unit training events, said method comprising the step of:
computerizing the allocation and logistics for ammunition requirements of the military unit training events.

2. The method of claim 1, further comprising the step of:
receiving forecasts of the training events.

3. The method of claim 2, further comprising the step of:
determining the ammunition requirements for the training events.

4. The method of claim 3, further comprising the step of:
allocating the ammunition for the training events.

5. The method of claim 3, further comprising the step of:
comparing the ammunition requirements with available ammunition inventories.

6. The method of claim 3, further comprising the step of:
adjusting the ammunition allocations to reflect the ammunition requirements and the ammunition inventories.

7. The method of claim 6, further comprising the step of:
requesting ammunition from supplier organizations for the training events.

8. The method of claim 7, further comprising the step of:
approving the ammunition allocations.

9. The method of claim 8, further comprising the step of:
including ammunition supplies from the supplier organizations into the ammunition inventories.

10. The method of claim 9, further comprising the step of:
distributing the approved ammunition allocations to user level units.

11. The method of claim 10, further comprising the step of:
making an accounting for physical distribution of the ammunition and its associated packaging material.

12. The method of claim 11, further comprising the step of:
returning residue from the ammunition and the packaging material for recycling.

13. A method of managing ammunition for military unit training events, for storage on at least one computer storage medium, said method comprising the steps of:
a. computerizing the allocation and logistics for ammunition requirements of the military unit training events; and
b. determining the type of training requested by a training unit in the military unit training event.

14. The method of computerized management of ammunition for military unit training events of claim 13, further comprising the step of:
receiving forecasts of the training events for an identified time frame from user level units.

15. The method of computerized management of ammunition for military unit training events of claim 14, further comprising the step of:
determining the ammunition requirements for the training events by comparison with data in a database.

16. The method of computerized management of ammunition for military unit training events of claim 15, further comprising the step of:
comparing the ammunition requirements with ammunition inventories on hand.

17. The method of computerized management of ammunition for military unit training events of claim 16, further comprising the step of:
adjusting ammunition allocations to reflect the ammunition requirements and the ammunition inventories.

18. The method of computerized management of ammunition for military unit training events of claim 17, further comprising the step of:
allocating the ammunition for the training events occurring within the identified time frame.

19. The method of computerized management of ammunition for military unit training events of claim 18, further comprising the step of:
requesting the ammunition from supplier organizations for the training events occurring within the identified time frame, wherein a parent organization consolidates customer requests for ammunition allocation and forwards the customer requests for ammunition allocation for approval.

20. The method of computerized management of ammunition for military unit training events of claim 19, further comprising the step of approving the ammunition allocations.

21. The method of computerized management of ammunition for military unit training events of claim 20, further comprising the step of including ammunition supplies from supplier organizations into the ammunition inventories.

22. The method of computerized management of ammunition for military unit training events of claim 21, further comprising the step of distributing the approved ammunition allocations to the user level units, wherein an accounting is made for physical distribution of the ammunition and packaging material, including return of residue after conclusion of the training events.

23. The method of computerized management of ammunition for military unit training events of claim 22, further comprising the step of identifying all authorized substitutes for a given ammunition product.

24. The method of computerized management of ammunition for military unit training events of claim 23, further comprising the step of identifying all weapon equipment that can use a given ammunition product.

25. The method of computerized management of ammunition for military unit training events of claim 24, further comprising the step of identifying all ammunition products usable by a given weapon.

26. The method of computerized management of ammunition for military unit training events of claim 25, further comprising the step of identifying all residue requirements for recovery and disposal for a given ammunition product.

27. The method of computerized management of ammunition for military unit training events of claim 26, further comprising the step of determining the number and types of vehicles required to transport the ammunition requirements.

28. The method of computerized management of ammunition for military unit training events of claim 27, further comprising the step of identifying hazard class and compatibility codes for the vehicles.

29. The method of computerized management of ammunition for military unit training events of claim 28, further comprising the step of matching the vehicles by hazard class and compatibility code with ammunition to be transported.

30. The method of computerized management of ammunition for military unit training events of claim 29, wherein forecasts of ammunition requirements are determined from the training plan documents of user level units.

31. The method of computerized management of ammunition for military unit training events of claim 30, wherein user level units have access to input forecasts and receive allocations.

32. The method of computerized management of ammunition for military unit training events of claim 31, said method further comprising the step of utilizing a plurality of tables of ammunition requirements for training events within a database, a plurality of table names, a plurality of fields within each of said plurality of tables, a plurality of forms for input of data, at least one computer-readable storage medium, at least one software program and a computer means for operating on said database by operation of said at least one software program.

33. A system for ammunition management comprising:
computer means operating on a database of training events and ammunition requirements thereof.

34. The system of claim 33, further comprising:
means for input of quantified requests for ammunition for training events from user level units.

35. The system of claim 34, further comprising:
at least one software program for controlling said computer means to operate on said database in concert with said quantified requests.

36. The system of claim 35, further comprising:
comparison means for matching inventory of ammunition with said quantified requests.

37. The system of claim 36, further comprising:
allocation means for adjusting ammunition stocks to priority rank of training events.

38. The system of claim 37, further comprising:
output means for providing approval requests and reports.

39. The system of claim 38, further comprising:
distribution means for distributing ammunition to user level units.

40. The system of claim 39, wherein said at least one software program utilizes structured query language instructions.

41. The system of claim 40, wherein said at least one software program utilizes forms with embedded computer software code therein.

42. At least one computer-readable tangible medium having instructions stored thereon for implementing a method of ammunition management, said instructions including the functions of:
a. receiving forecasts of training events from user level units; and
b. utilizing the computer to process said forecasts of the training events into ammunition requirements.

43. The instructions on said tangible medium of claim 42 further comprising the functions of:
utilizing the computer to consolidate forecasts for a plurality of user level units.

44. The instructions on said tangible medium of claim 43 further comprising the functions of:
utilizing the computer to determine the total ammunition requirements for all user level units;

45. The instructions on said tangible medium of claim 44 further comprising the functions of:
utilizing the computer to compare the total ammunition requirements with ammunition stock on hand.

46. The instructions on said tangible medium of claim 45 further comprising the functions of:
allocating approved ammunition to user level units.

47. The instructions on said tangible medium of claim 46, wherein said instructions further include the function of distributing allocated ammunition to user level units.

48. The instructions on said tangible medium of claim 47, wherein said instructions further include the function of recovering unused ammunition stocks and other residue from user level units.

49. The instructions on said tangible medium of claim 48, wherein said instructions further include the function of requesting approval for use of ammunition to meet requests.

50. A computer readable tangible medium storing instructions for implementing a method of ammunition management, wherein the contents of said medium cause a computer system to operate on a database and external information, by performing the steps of:
a. receiving forecasts of training events;
b. calculating ammunition requirements of the training events;
c. comparing ammunition requirements to existing ammunition stocks;
d. allocating ammunition to user level units based on ammunition stocks, forecast and priority of training events;
e. distributing allocated ammunition to user level units; and
f. recovering spent ammunition and packaging from user level units.

51. A computer device comprising:
means for determining the allocation and logistics of ammunition based upon training events.

52. The computer device of claim 51, further comprising:
means for receiving training event forecasts.

53. The computer device of claim 52, further comprising:
means for determining ammunition requirements to meet the training event forecasts.

54. The computer device of claim 53, further comprising:
means for comparing the ammunition requirements to ammunition stocks on hand.

55. The computer device of claim 54, further comprising:
means for obtaining authorization to utilize stocks of ammunition to meet the ammunition requirements.

56. The computer device of claim 55, further comprising:
means for requesting additional stocks of ammunition to meet the ammunition requirements, if needed.

57. The computer device of claim 56, further comprising:
means for allocating the ammunition requirements to user level units.

58. The computer device of claim 57, further comprising:
means for distributing the ammunition requirements to user level units.

59. The computer device of claim 58, further comprising:
means for recovering spent ammunition and packaging thereof after end of the training events.

60. An apparatus for managing ammunition requirements and supply for weapon training events, said apparatus comprising:
a database of ammunition requirements, said database accessible via a network.

61. The apparatus of claim 60, further comprising:
training forecasts supplied by user level units for defining the ammunition requirements therefor.

62. The apparatus of claim 61, further comprising:
a software program, said software program comprising program operations selected from the group consisting of means for obtaining ammunition requirements of weapon training events from said database, means for calculating total ammunition requirements by operation on said database, means for comparing the total ammunition requirements for the training forecasts with ammunition inventories on hand, means for transforming said forecasts into allocations of ammunition inventories, and combinations thereof.

63. The apparatus of claim 62, further comprising:
means for distributing ammunition to the user level units.

64. A method for management of ammunition for military units, for storage on at least one computer storage medium, comprising the steps of:
a. receiving forecasts of ammunition requirements for a period of time from user level units;
b. comparing ammunition requirements with ammunition inventories on hand;
c. adjusting ammunition allocations to reflect ammunition requirements and ammunition inventories;
d. allocating ammunition to the user level units within the period of time;
e. requesting ammunition from supplier organizations for ammunition requirements for the period of time, wherein a parent organization consolidates customer requests and forwards the customer requests for approval;
f. including ammunition supplies from supplier organizations into inventory; and
g. distributing approved ammunition allocations to user level units, wherein an accounting is made for physical distribution of ammunition.

65. A system for ammunition management comprising:
a software driven computer means for input of quantified requests for ammunition from user level units.

66. The system for ammunition management of claim 65 further comprising:
means for comparing inventory of ammunition with said quantified requests.

67. The system for ammunition management of claim 66 further comprising:
means for allocating and adjusting ammunition stocks to user level units.

68. The system for ammunition management of claim 67 further comprising:
means for providing approval requests and reports.

69. The system for ammunition management of claim 68 further comprising:
means for distributing ammunition to user level units.

70. An apparatus for managing ammunition requirements and supply, comprising:
a. a computer;
b. a network, in communication with an external communications link;
c. ammunition requirements forecasts supplied by user level units;
d. software program comprising means for calculating total ammunition requirements for all user level units, means for comparing the total ammunition requirements with ammunition inventories on hand, and means for transforming the ammunition requirements and ammunition inventories into allocations of ammunition to the user level units; and
e. means for distributing ammunition to the user level units.

71. The apparatus for managing ammunition requirements and supply of claim 70, further comprising scanning means for inventory control.

72. The apparatus for managing ammunition requirements and supply of claim 71, further comprising ammunition contained in packages having a bar code label thereon.

73. The apparatus for managing ammunition requirements and supply of claim 72, further comprising storage magazines having bar code labels thereon.

74. An apparatus comprising at least one computer and at least one computer-readable tangible medium means for storing instructions for implementing a method of ammunition management, said instructions including the function of:
utilizing said at least one computer to consolidate forecasts for a plurality of user level units.

75. The instructions stored on the apparatus of claim 74, wherein said instructions further comprise the function of:
utilizing said computer to determine the total ammunition requirements for all user level units.

76. The instructions stored on the apparatus of claim 75, wherein said instructions further comprise the function of:
utilizing said computer to compare the total ammunition requirements with ammunition stock on hand.

77. The instructions stored on the apparatus of claim 76, wherein said instructions further comprise the function of:
requesting approval for use of ammunition to meet requests.

78. The instructions stored on the apparatus of claim 77, wherein said instructions further comprise the function of:
allocating approved ammunition to user level units.

79. The instructions stored on the apparatus of claim 78, wherein said instructions further comprise the function of:
distributing allocated ammunition to user level units.
